(19) United States
(12) Patent Application Publication
(10) Pub. No.: US 2025/0308431 A1
(43) Pub. Date: Oct. 2, 2025

(54) DEVICE AND METHOD FOR FAILURE DETECTION OF ICON IMAGE DATA PATH

(71) Applicant: Synaptics Incorporated, San Jose, CA (US)

(72) Inventors: Ryosei Makino, Saitama (JP); Ken Sato, Kanagawa (JP); Hirobumi Furihata, Tokyo (JP)

(21) Appl. No.: 18/619,057

(22) Filed: Mar. 27, 2024

(51) Int. Cl. G09G 3/20; G09G 5/06

(52) U.S. Cl. CPC G09G 3/2096; G09G 3/2044; G09G 5/06; G09G 2330/12; G09G 2340/12

(57) ABSTRACT

A circuit includes an icon image data path and a diagnostic circuit. The icon image data path includes an icon overlay circuit and an image processing circuit. The icon overlay circuit generates icon-overlayed image data corresponding to an icon-overlayed image in which an icon image is overlayed on a base image. The image processing circuit is configured to process the icon-overlayed image data to generate processed image data. The diagnostic circuit is configured to store a conversion lookup table based on input-to-output correlation of the image processing circuit, extract icon-relevant processed image data from the processed image data, and convert the icon-relevant processed image data into reproduced icon image data based on the conversion lookup table. The diagnostic circuit is further configured to detect a failure of the icon image data path based on the icon image data and the reproduced icon image data.

### TECHNICAL FIELD

This disclosure relates generally to failure detection of display systems, more particularly, to failure detection of an icon image data path configured to generate and process icon-overlayed images.

### BACKGROUND

Display systems may be configured to display images containing one or more icons such as tell-tale icons to provide users with various information, such as system status information, alert information, and warning information. The icon referred to herein is a small pictogram that visually represents an object, an indication, an action, a symbol, or other concept. For example, when a data transfer link is lost in a display system, the display system may be configured to display an icon that indicates the loss of data transfer link. Such display systems may have an icon overlay function to overlay one or more icons on a base image generated by an original image source (such as a host) to render an icon-overlayed image.

### SUMMARY

This summary is provided to introduce, in a simplified form, a selection of concepts that are further described below. This summary is not necessarily intended to identify key features or essential features of the present disclosure. The present disclosure may include the following various aspects and embodiments.

In an exemplary embodiment, the present disclosure provides a circuit that includes an icon image data path and a diagnostic circuit. The icon image data path includes an icon overlay circuit and an image processing circuit. The icon overlay circuit is configured to generate icon-overlayed image data based on input image data corresponding to a base image and icon image data corresponding to an icon image. The icon-overlayed image data corresponds to an icon-overlayed image in which the icon image is overlayed on the base image. The image processing circuit is configured to process the icon-overlayed image data to generate processed image data. The diagnostic circuit is configured to extract icon-relevant processed image data from the processed image data and convert the icon-relevant processed image data into reproduced icon image data based on input-to-output correlation of the image processing circuit. The diagnostic circuit is further configured to detect a failure of the icon image data path based on the icon image data and the reproduced icon image data.

In another exemplary embodiment, the present disclosure provides a display system that includes a display panel, an icon image data path, a diagnostic circuit, and a driver circuit. The icon image data path includes an icon overlay circuit and an image processing circuit. The icon overlay circuit is configured to generate icon-overlayed image data based on input image data corresponding to a base image and icon image data corresponding to an icon image. The icon-overlayed image data corresponds to an icon-overlayed image in which the icon image is overlayed on the base image. The image processing circuit is configured to process the icon-overlayed image data to generate processed image data. The diagnostic circuit is configured to extract icon-relevant processed image data from the processed image data and convert the icon-relevant processed image data into reproduced icon image data based on input-to-output correlation of the image processing circuit. The diagnostic circuit is further configured to detect a failure of the icon image data path based on the icon image data and the reproduced icon image data. The driver circuit is configured to drive the display panel based on the processed image data.

In yet another exemplary embodiment, the present disclosure provides a method for detecting a failure of an icon image data path. The method includes generating, by an icon overlay circuit of the icon image data path, icon-overlayed image data based on input image data corresponding to a base image and icon image data corresponding to an icon image. The icon-overlayed image data corresponds to an icon-overlayed image in which the icon image is overlayed on the base image. The method further includes processing, by an image processing circuit of the icon image data path, the icon-overlayed image data to generate processed image data. The method further includes extracting icon-relevant processed image data from the processed image data and converting the icon-relevant processed image data into reproduced icon image data based on input-to-output correlation of the image processing circuit. The method further includes detecting a failure of the icon image data path based on the icon image data and the reproduced icon image data.

Other features and aspects are described in further detail below with reference to the attached drawings.

### BRIEF DESCRIPTION OF THE DRAWINGS

FIGS. 1A to 1D are block diagrams showing example configurations of display systems, according to one or more embodiments.

FIG. 2 shows an example configuration of a bridge circuit, according to one or more embodiments.

FIG. 3 shows an example configuration of an icon overlay and image processing block, according to one or more embodiments.

FIG. 4 shows examples of an icon color table setting, icon color table data, processed icon color table data, and a conversion lookup table (LUT), according to one or more embodiments.

FIG. 5 shows an example process for generating a conversion LUT, according to one or more embodiments.

FIG. 6 shows an example process for detecting a failure of an icon image data path in a frame period, according to one or more embodiments.

FIG. 7 is a timing diagram showing an example operation of an icon overlay and image processing block, according to one or more embodiments.

FIG. 8 shows an example partial configuration of an icon data convert circuit, according to one or more embodiments.

FIG. 9A show examples of an icon color table setting and a conversion LUT, according to one or more embodiments.

FIG. 9B shows examples of R, G, and B comparison result values, according to one or more embodiments.

FIG. 10 shows an example configuration of an icon overlay and image processing block, according to other embodiments.

FIG. 11 shows an example partial configuration of an icon data convert circuit, according to one or more embodiments.

FIG. 12A is a timing diagram showing an example operation of an icon overlay and image processing block, according to one or more embodiments.

FIG. 12B is a timing diagram showing an example operation of an icon overlay and image processing block, according to other embodiments.

For ease of understanding, where possible, identical reference numerals have been used, to designate elements that are common to the figures. It is contemplated that elements disclosed in one embodiment may be utilized in other embodiments without specific recitation. Suffixes may be appended to reference numerals to distinguish elements from one another. The drawings referenced herein are not be to be construed as being drawn to scale unless specifically noted. In addition, the drawings are often simplified and details or components are omitted for clarity of presentation and explanation. The drawings and discussion serve to explain principles discussed below.

### DETAILED DESCRIPTION

The following detailed description is exemplary in nature and is not intended to limit the disclosure or the applications and uses of the disclosure. Further, there is no intention to be bound by any expressed or implied theory presented in the preceding background, summary and brief description of the drawings, or in the following detailed description.

In the following detailed description, numerous specific details are set forth in order to provide a more thorough understanding of the disclosed technology. However, it will be apparent to one of ordinary skill in the art that the disclosed technology may be practiced without these specific details. In other instances, well-known features have not been described in detail to avoid unnecessarily complicating the description.

The term “coupled” as used herein means connected directly to or connected through one or more intervening components or circuits. Further, throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Display systems may be configured to display images containing one or more icons such as tell-tale icons to provide users with various information, such as system status information, alert information, and warning information. Such display systems may have an icon overlay function to overlay one or more icons on a base image generated by an original image source (such as a host) to render an icon-overlayed image. In implementations where a display system includes a bridge circuit configured to deliver image data received from a host to one or more display driver circuits configured to drive a display panel, the icon overlay function may be performed by the bridge circuit. In other implementations, the icon overlay function may be performed by one or more display driver circuits.

Meanwhile, display systems may also have an image processing function to improve image quality. The image processing may include, but not limited to, white balance tuning, gamma correction, contrast enhancement, and so on. In some implementations, the image processing may be applied to the icon-overlayed image.

Since icons may be used to provide important information, such as safety-related information, it may be desirable to ensure that the icons are displayed as desired in the icon-overlayed image. To achieve this, it would be advantageous to detect a failure of an icon image data path that implements the icon overlay function and the image processing function, because the failure may cause collapse of the icon-overlayed image. However, the image processing function may affect the failure detection of the icon image data path, because the image processing function is originally intended to modify data of icon images contained in the icon-overlayed image and therefore changes in data of the icon images do not necessary indicate the occurrence of the failure. Accordingly, there is a technical need for detecting the failure of the icon image data path that implements the icon overlay function and the image processing function. The present disclosure provides various techniques for detecting the failure of the icon image data path.

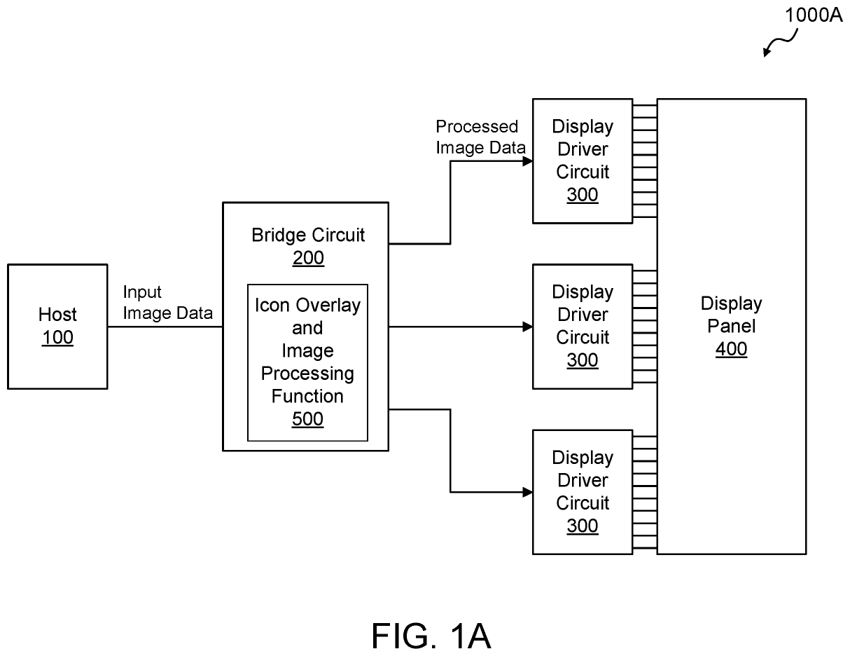

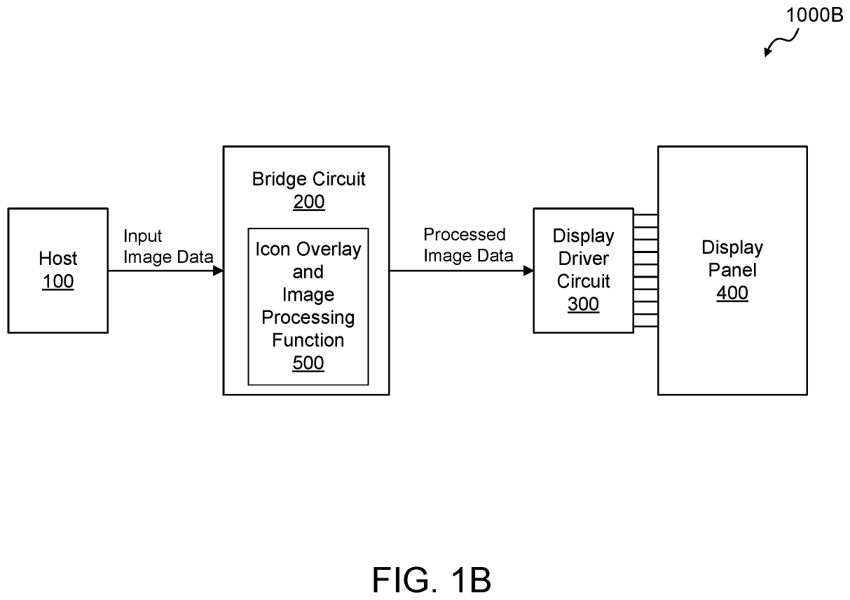

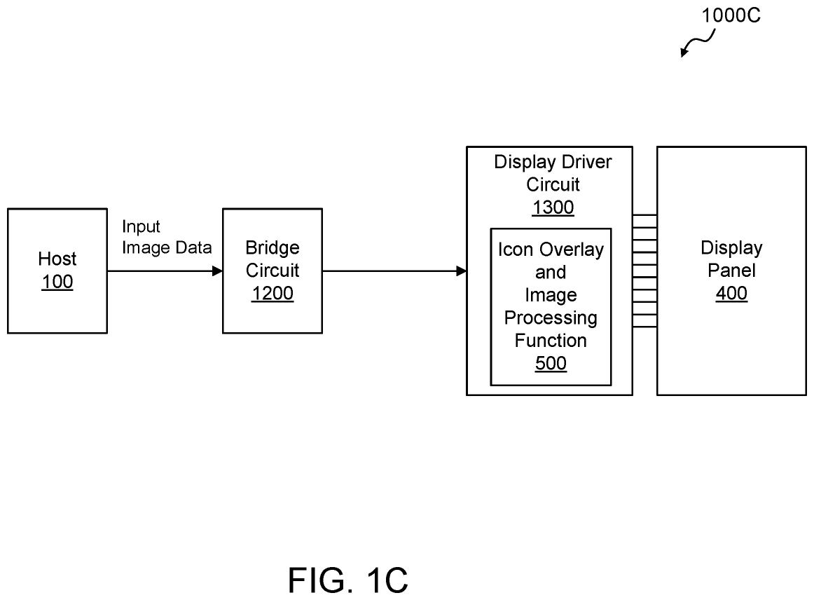

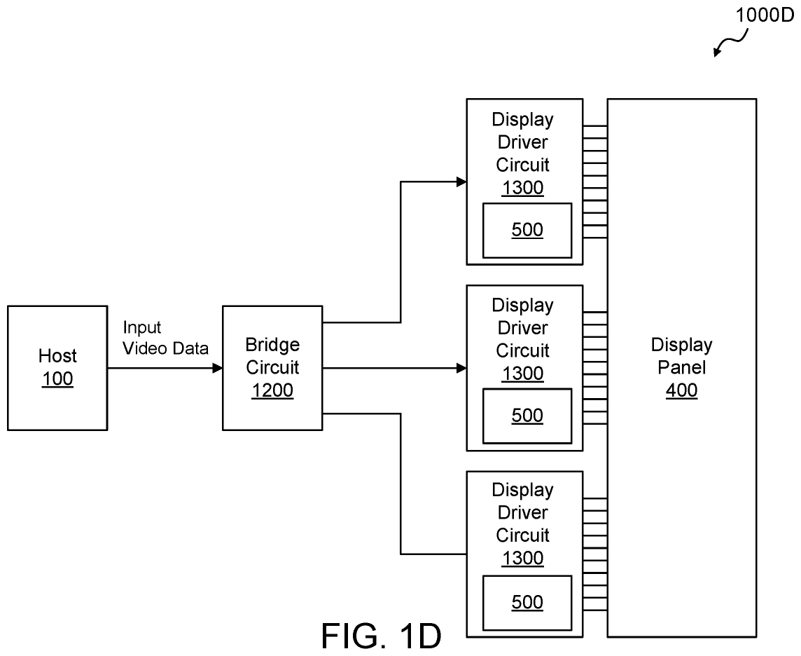

FIG. 1A is a block diagram showing an example configuration of a display system 1000A, according to one or more embodiments. In the shown embodiment, the display system 1000A includes a host 100, a bridge circuit 200, a plurality of display driver circuits 300, and a display panel 400. The host 100 is communicatively coupled to the bridge circuit 200, and the bridge circuit 200 is communicatively coupled to the display driver circuits 300. In one implementation, the data communication between the host 100 and the bridge circuit 200 may be performed according to the embedded Display Port (eDP) protocol, while the data communication between the bridge circuit 200 and the display driver circuits 300 may be performed according to the low voltage differential signaling (LVDS) protocol.

The host 100 is configured to provide input image data to the bridge circuit 200. The input image data corresponds to a base image and may include pixel data for respective pixels of the display panel 400. The pixel data of each pixel may include a red (R) graylevel value, a green (G) graylevel value, and a blue (B) graylevel value. The host 100 may be an application processor, a central processing unit (CPU), or other processors configured to provide the input image data.

The bridge circuit 200 is configured to provide communication between the host 100 and the display driver circuits 300. The bridge circuit 200 is further configured to provide an icon overlay and image processing function 500. More specifically, the bridge circuit 200 is configured to apply icon overlay processing to the input image data to generate icon-overlayed image data corresponding to an icon-overlayed image in which one or more icon images are overlayed on the base image. The bridge circuit 200 is further configured to perform image processing on the icon-overlayed image data to generate the processed image data. The image processing performed by the icon overlay and image processing function 500 may include, but is not limited to, white balance tuning, and gamma correction, contrast enhancement, and so on. The resulting image data acquired by the icon overlay and image processing function 500 may be referred to as processed image data. The processed image data generated by the bridge circuit 200 is provided to the display driver circuits 300. In some embodiments, the bridge circuit 200 may be a discrete integrated circuit (IC), such as a bridge circuit IC. The display driver circuits 300 are configured to drive the display panel 400 in response to the processed image data. Each of the display driver circuits 300 may be a discrete IC such as a display driver IC (DDIC). While FIG. 1A shows that the display system 1000A includes three display driver circuits 300, the display system may include more than or less than three display driver circuits 300. FIG. 1B shows a display system 1000B that includes one display driver circuit 300.

In alternative embodiments, the icon overlay and image processing function 500 may be implemented by display drivers. FIG. 1C shows an example configuration of a display system 1000C, according to one or more embodiments. In the shown embodiment, the display system 1000C includes a bridge circuit 1200 and a display driver circuit 1300. The bridge circuit 1200 is configured to receive input image data from the host 100 and forward the input image data to the display driver circuit 1300. The display driver circuit 300 has the icon overlay and image processing function 500 to generate the processed image data from the input image data, and is configured to drive the display panel 400 in response to the processed image data. While FIG. 1C shows that the display system 1000C includes one display driver circuit 300, the display system may include more than one display driver circuit 300. FIG. 1D shows a display system 1000D including three display driver circuits 300, each having the icon overlay and image processing function 500.

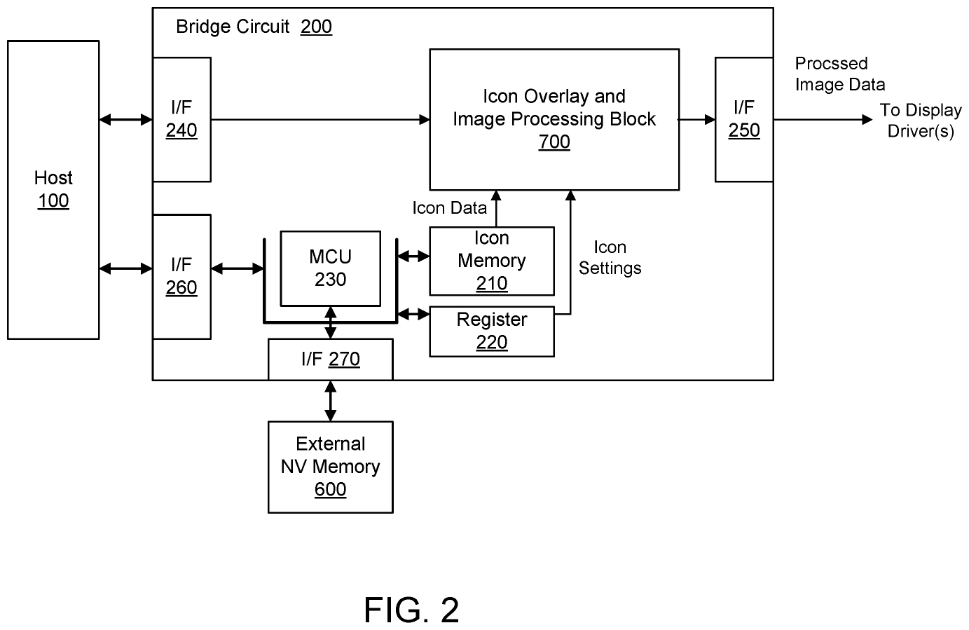

FIG. 2 shows an example configuration of the bridge circuit 200, according to one or more embodiments. In the shown embodiment, the bridge circuit 200 includes an icon overlay and image processing block 700, an icon memory 210, a register 220, a micro control unit (MCU) 230, and interfaces (I/Fs) 240, 250, 260, and 270. The icon overlay and image processing block 700 is configured to provide the icon overlay and image processing function 500 (shown in FIGS. 1A and 1B). More specifically, the icon overlay and image processing block 700 is configured to receive input image data from the host 100 via the interface 240 and to perform icon overlay processing on the input image data to generate icon-overlayed image data corresponding to an icon-overlayed image in which one or more icon images are overlayed on the base image. The icon overlay and image processing block 700 is further configured to apply image processing to the icon-overlayed image data to generate the processed image data. The processed image data is provided to the display driver circuit(s) 300 via the interface 250. Details of the icon overlay and image processing block 700 will be described later.

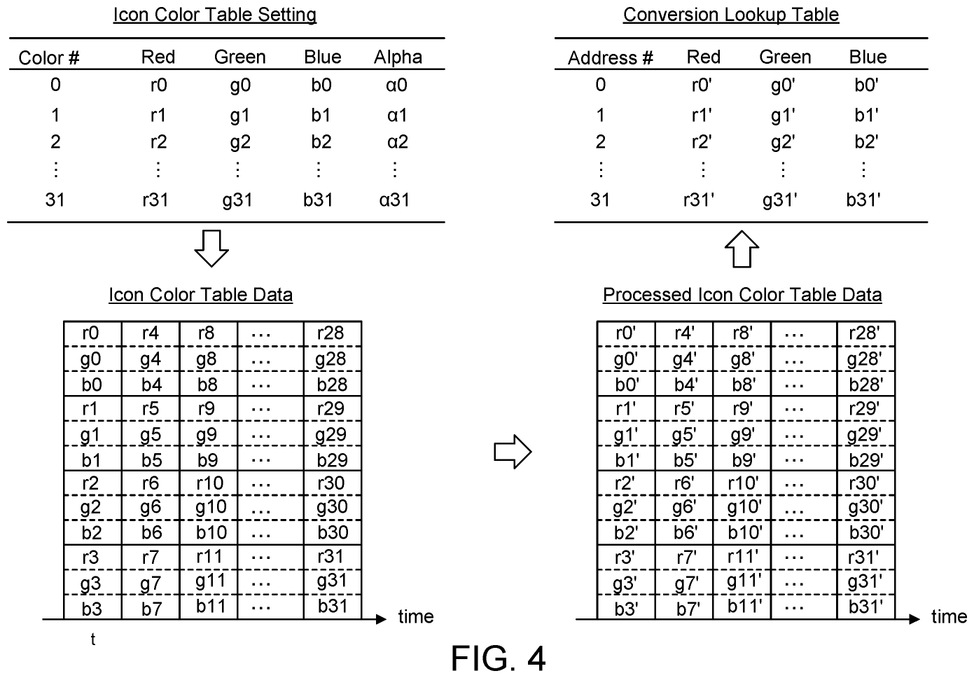

The icon memory 210 is configured to store icon data for each of types of icon images. The icon data for each icon image includes color numbers (or color identifiers (IDs) that indicate colors of respective pixels of that icon image. The register 220 is configured to store icon settings used in the icon overlay and image processing block 700. The icon settings stored in the register 220 may include an icon color table setting that indicates R, G, and B graylevel values for each allowed value of the color numbers (shown in the upper left table of FIG. 4). The icon settings stored in the register 220 may further include icon configuration, such as types and locations of icon images to be overlayed on the base image. In some embodiments, the icon memory 210 and the register 220 may be accessible to an external non-volatile (NV) memory 600 configured to store icon data for each of the types of icon images and the default icon settings. In such embodiments, upon startup of the bridge circuit 200, the icon memory 210 is configured to retrieve the icon data from the external NV memory 600 and the register 220 is configured to retrieve the icon settings from the external NV memory 600.

The MCU 230 is configured to control the image processing icon overlay and image processing block 700. In one implementation, the MCU 230 may be configured to control the image processing icon overlay and image processing block 700 by modifying the settings stored in the register 220. The MCU 230 may further be configured to monitor the data communication between the host 100 and the bridge circuit 200. In such embodiments, the MCU 230 may be configured to, upon detecting a communication error in the data communication between the host 100 and the bridge circuit 200, update the icon settings stored in the register 220 to allow an error message icon to be overlayed on the base image.

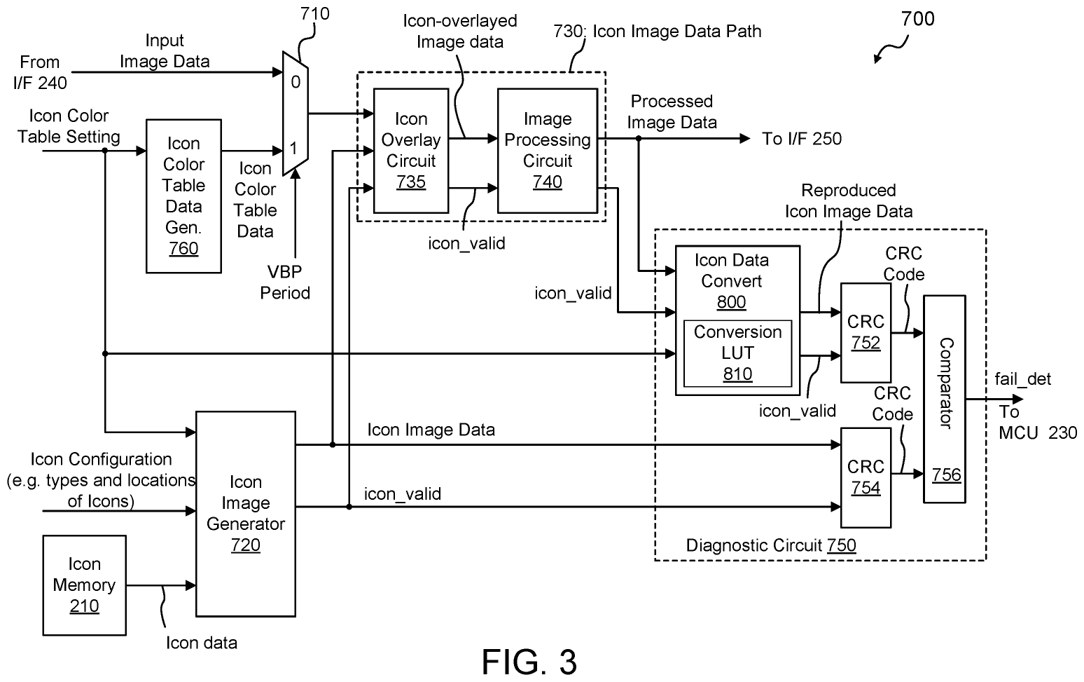

FIG. 3 shows an example configuration of the icon overlay and image processing block 700, according to one or more embodiments. In the shown embodiment, the icon overlay and image processing block 700 includes a selector 710, an icon image generator circuit 720, an icon image data path 730, a diagnostic circuit 750, and an icon color table data generator circuit 760. The icon image data path 730 is configured to process the input image data to generate processed image data and includes an icon overlay circuit 735 and an image processing circuit 740.

The selector 710 is configured to receive the input image data from the interface 240 and icon color table data from the icon color table data generator circuit 760, and to forward a selected one of the input image data or the icon color table data to the icon overlay circuit 735. The icon color table data includes R, G, and B graylevel values for each of a predetermined set of colors used in icon images. The icon color table data may include R, G, and B graylevel values for each of all the allowed color numbers (also see the lower left table of FIG. 4). The icon color table data generator circuit 760 is configured to generate and provide the icon color table data to the selector 710 based on the icon color table setting stored in the register 220. Details of the icon color table data will be described later. In one implementation, the selector 710 is configured to select the icon color table data during the vertical back porch (VBP) period in each frame period, and select the input image data during the remaining period in each frame period.

The icon image generator circuit 720 is configured to generate icon image data for each icon image to be incorporated in the icon-overlayed image based on the icon data stored in the icon memory 210 and the icon settings stored in the register 220 (shown in FIG. 2). The icon image data for an icon image may include pixel data for respective pixels of that icon image, wherein the pixel data for a pixel may include R, G, and B graylevel values of that pixel. When generating icon image data for an icon image of interest, the icon image generator circuit 720 retrieves the icon data of that icon image from the icon memory 210. The icon image generator circuit 720 then determines the R, G, and B graylevel values of the pixel data of the icon image data for the respective pixels of the icon image of interest based on the color numbers of the respective pixels indicated by the icon data with reference to the icon color table setting. The icon image generator circuit 720 is further configured to generate an icon overlay validation signal icon_valid that indicates whether pixel data of the input image data currently input to the icon overlay circuit 735 is to be replaced with pixel data of the icon image data.

The icon overlay circuit 735 is configured to perform icon overlay processing on the input image data to generate an icon-overlayed image data. The icon-overlayed image data corresponds an icon-overlayed image in which icon images is overlayed on the base image. In one implementation, the icon overlay circuit 735 is configured to receive icon image data for each icon to be incorporated into the icon-overlayed image and the icon overlay validation signal icon_valid from the icon image generator circuit 720. The icon overlay circuit 735 is configured to achieve the icon overlay processing by replacing pixel data of the input image data with pixel data of the icon image data as indicated by the icon overlay validation signal data icon_valid. The icon overlay circuit 735 is further configured to forward the icon overlay validation signal data icon_valid to the image processing circuit 740.

The image processing circuit 740 is configured to apply image processing to the icon-overlayed image data to generate processed image data. The image processing performed by the image processing circuit 740 may include, but is not limited to, white balance tuning, and gamma correction, contrast enhancement, and the like. The image processing circuit 740 is further configured to provide the processed image data to the display driver circuits 300 via the interface 250, and also to the diagnostic circuit 750. The image processing circuit 740 is further configured to forward the icon overlay validation signal data icon_valid to the diagnostic circuit 750. The icon overlay validation signal icon_valid provided by the image processing circuit 740 to the diagnostic circuit 750 indicates whether or not pixel data of the processed image data corresponds to pixels of an icon image.

The diagnostic circuit 750 is configured to detect a failure of the icon image data path 730 and to generate a failure detection signal fail_det that indicates the result of the detection of the failure of the icon image data path 730. The failure detection is performed based on the processed image data received from the image processing circuit 740 and the icon image data received from the icon image generator circuit 720. In the shown embodiment, the diagnostic circuit 750 includes an icon data convert circuit 800, cyclic redundancy check (CRC) circuits 752 and 754, and a comparator 756.

The icon data convert circuit 800 is configured to store a conversion lookup table (LUT) 810 containing information about the input-to-output correlation of the image processing circuit 740, and to use the conversion LUT 810 to generate reproduced icon image data for each icon image from the processed image data. Details of the conversion LUT 810 will be described later. More specifically, the icon data convert circuit 800 is configured to extract icon-relevant processed image data for each icon image from the processed image data with reference to the icon overlay validation signal icon_valid received from the image processing circuit 740. The icon-relevant processed image data for an icon image is part of the processed image data corresponding to the icon image. The icon data convert circuit 800 is further configured to convert the icon-relevant processed image data for each icon image into reproduced icon image data for each icon image by performing “inverse processing” of the image processing performed by the image processing circuit 740 based on the input-to-output correlation of the image processing circuit 740. The icon data convert circuit 800 is configured to refer to the conversion LUT 810 and the icon color table setting when converting the icon-relevant processed image data into the reproduced icon image data. The failure of the icon image data path 730 is detected based on a comparison between the reproduced icon image data generated by the icon data convert circuit 800 and the original icon image data generated by the icon image generator circuit 720.

The CRC circuit 752 is configured to calculate CRC codes of the reproduced icon image data for the icon images, and the CRC circuit 754 is configured to calculate CRC codes of the original icon image data generated by the icon image generator circuit 720 for the icon images. In one implementation, the CRC circuit 752 may be configured to collectively calculate one CRC code of the reproduced icon image data for all of the icon images contained in each frame image, and the CRC circuit 754 may be configured to collectively calculate one CRC code of the original icon image data for all of the icon images contained in that frame image.

The comparator 756 is configured to compare the CRC codes generated by the CRC circuits 752 and 754 and generate the failure detection signal fail_det based on the result of the comparison. In one implementation, the comparator 756 may be configured to assert the failure detection signal fail_det to indicate occurrence of a failure when the CRC codes generated by the CRC circuits 752 and 754 are different from each other.

In alternative implementations, error detection codes of the reproduced icon image data and the original icon image data may be calculated for icon images instead of the CRC codes. In such implementations, a failure of the icon image data path 730 may be detected based on a comparison between the error detection codes of the reproduced icon image data and the original icon image data.

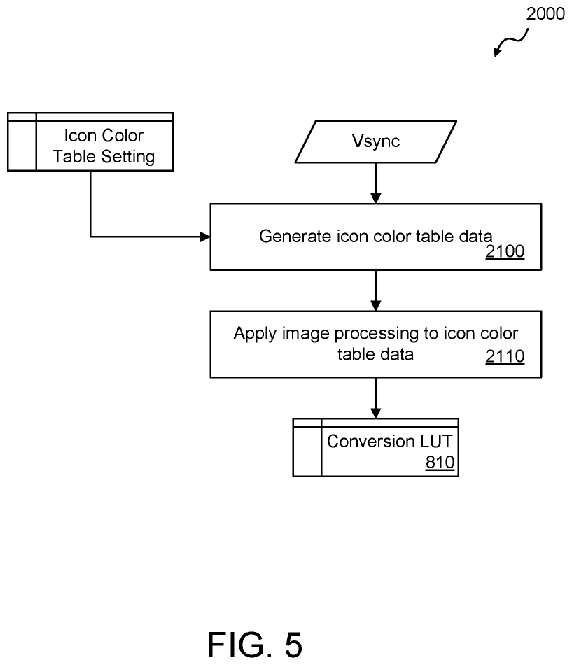

FIG. 5 shows an example process 2000 for generating the conversion LUT 810, according to one or more embodiments. In one or more embodiments, the conversion LUT 810 is generated based on the icon color table setting and stored into the icon data convert circuit 800 during each vertical back porch (VBP) period in each frame period (or vertical synchronization period). Referring to FIG. 5, in step 2100, the icon color table data generator circuit 760 generates icon color table data from the icon color table setting and provides the color table to the image processing circuit 740.

The left column of FIG. 4 shows examples of the icon color table setting and the icon color table data generated from the icon color table setting. The icon color table setting describes R, G, and B graylevel values for each color number. In the shown embodiment, the color number range is from 0 to 31, and the R, G, and B graylevel values of color number j are rj, gj, and bj, respectively. The icon color table data is generated by rearranging the R, G, and B graylevel values for the respective color numbers described in the icon color table setting. In the shown embodiment, the icon color table data is provided to the image processing circuit 740 in units of four color numbers. For example, the R, G, and B graylevel values r0, g0, b0, r1, g1, b1, r2 g2, b2, r3, g3, and b3 of color numbers “O”, “1”, “2”, and “3” (shown in the leftmost column) are first generated and provided to the image processing circuit 740, and the R, G, and B graylevel values r4, g4, b4, r5, g5, b5, r6, g6, b6, r7, g7, and b7 of color numbers “4”, “5”, “6”, and “7” (shown in the second leftmost column) are then generated and provided to the image processing circuit 740. A similar process is repeated to until provision of the R, G, and B graylevel values of all the possible color numbers is completed.

Referring back to FIG. 5, the image processing circuit 740 applies image processing to the icon color table data to generate processed icon color table data in step 2110. The processed icon color table data is provided to the icon data convert circuit 800, and the icon data convert circuit 800 rearranges the processed icon color table data to generate the conversion LUT 810. The right column of FIG. 4 shows examples of the processed icon color table data and the conversion LUT 810 generated from the processed icon color table data. The processed icon color table data includes processed R, G, and B graylevel values of the respective color numbers. In FIG. 4, the processed R, G, and B graylevel values for color number j are indicated by rj′, gj′, bj′. As is the case with the icon color table data, the processed icon color table data is output provided to the icon data convert circuit 800 in units of four color numbers. For example, the processed R, G, and B graylevel values r0′, g0′, b0′, r1′, g1′, b1′, r2′, g2′, b2′, r3′, g3′, and b3′ of color numbers “0”, “1”, “2”, and “3” (shown in the leftmost column) are first generated and provided to the icon data convert circuit 800, and the processed R, G, and B graylevel values r4′, g4′, b4′, r5′, g5′, b5′, r6′, g6′, b6′, r7′, g7′, and b7′ of color numbers “4”, “5”, “6”, and “7” (shown in the second leftmost column) are then generated and provided to the icon data convert circuit 800. A similar process is repeated to until provision of the processed R, G, and B graylevel values of all the possible color numbers is completed. The conversion LUT 810 describes the processed R, G, and B graylevel values for each color number. The icon data convert circuit 800 stores the processed R, G, and B graylevel values for each color number in the address determined based on that color number. In one implementation, the processed R, G, and B graylevel values rj′, gj′, and bj′ for color number “j” may be stored in address #j. The conversion LUT 810 thus generated contains information about the input-to-output correlation of the image processing performed by the image processing circuit 740, allowing the icon data convert circuit 800 to generate the reproduced icon image data for each icon image by inverse processing.

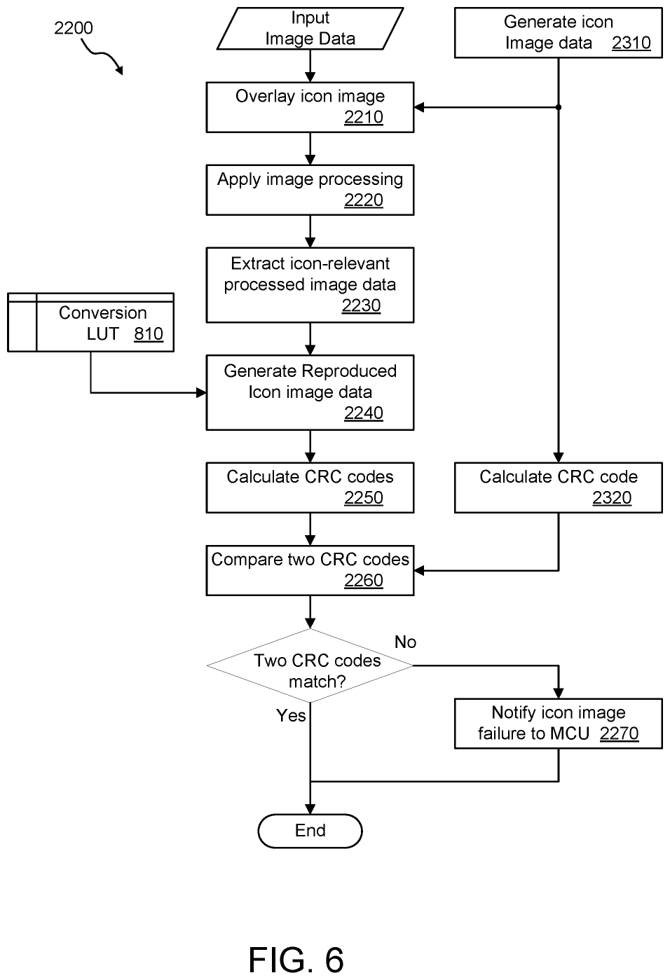

FIG. 6 shows an example process 2200 for detecting a failure of the icon image data path 730 in a frame period, according to one or more embodiments. The process begins with providing input image data to the icon overlay and image processing block 700. In step 2310, the icon image generator circuit 720 generates icon image data for respective icon images to be overlayed on the base image. In step 2210, the icon overlay circuit 735 performs icon overlay processing to generate icon-overlayed image data which corresponds to an icon-overlayed image in which the icon images are overlayed on the base image. In step 2220, the image processing circuit 740 applies image processing to the icon-overlayed image data to generate processed image data. In step 2230, the icon data convert circuit 800 extracts icon-relevant processed image data from the processed image data received from the image processing circuit 740. In step 2240, the icon data convert circuit 800 generates reproduced icon image data from the icon-relevant processed image data with reference to the conversion LUT 810. In step 2250, the CRC circuit 752 calculates a CRC code of the reproduced icon image data for all the icon images contained in the frame image displayed in the frame period. In step 2320, the CRC circuit 754 calculates a CRC code of the original icon image data for all the icon images contained in the frame image displayed in the frame period. In step 2260, the comparator 756 compares the two CRC codes generated by the CRC circuits 752 and 754 and generates the failure detection signal fail_det based on the result of the comparison. If the two CRC codes do not match, the comparator 756 asserts the failure detection signal fail_det to notify the MCU 230 of the detection of an icon image failure (or a failure of the icon image data path 730) in step 2270.

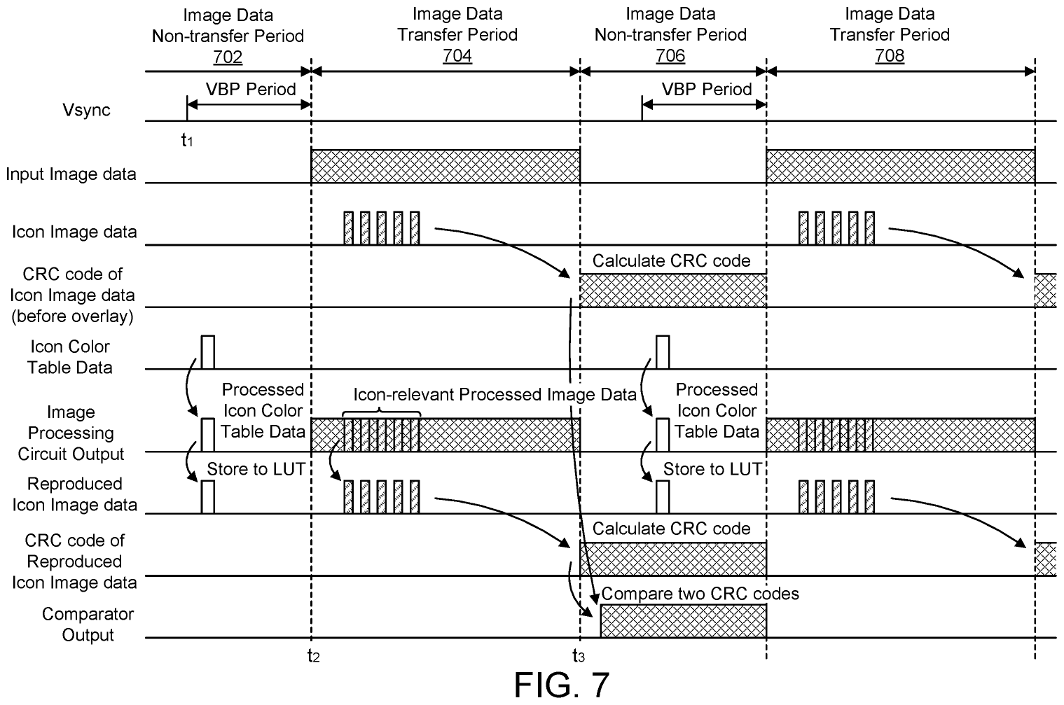

FIG. 7 is a timing diagram showing an example operation of the icon overlay and image processing block 700, according to one or more embodiments. In FIG. 7, “Vsync” denotes a vertical synchronization signal that defines frame periods. Each frame period is defined as a period between successive assertions of the vertical synchronization signal, and one frame image is displayed during each frame period. Image data non-transfer periods and image data transfer periods are alternately arranged in the time domain. During the image data non-transfer periods, no input image data is transferred to the icon overlay and image processing block 700, and during one image data transfer period, input image data for one frame image is transferred to the icon overlay and image processing block 700. Shown in FIG. 7 are two image data non-transfer periods 702, 706 and two image data transfer periods 704 and 708.

At time t₁ in the image data non-transfer period 702, the vertical synchronization signal Vsync is asserted and a vertical back porch (VBP) period is initiated in response to the assertion of the vertical synchronization signal Vsync. During the VBP period, icon color table data is generated by the icon color table data generator circuit 760, and the icon color table data is processed by the image processing circuit 740 to generate processed icon color table data. The conversion LUT 810 is generated from the processed icon color table data and stored in the icon data convert circuit 800. The conversion LUT 810 may be generated by the process shown in FIG. 5.

The image data transfer period 704 is then initiated at time t₂. During the image data transfer period 704, input image data corresponding to a base image is transferred to the icon overlay and image processing block 700. Meanwhile, the icon image generator circuit 720 generates icon image data for icon images to be overlayed on the base image. The icon overlay circuit 735 performs icon overlay processing to generate icon-overlayed image data which corresponds to an icon-overlayed image in which the icon images are overlayed on the base image, and the image processing circuit 740 applies image processing to the icon-overlayed image data to generate processed image data. A frame image corresponding to the processed image data is displayed during the image data transfer period 704. Further, the icon data convert circuit 800 extracts icon-relevant processed image data from the processed image data received from the image processing circuit 740, and converts the icon-relevant processed image data into reproduced icon image data with reference to the conversion LUT 810.

The image data non-transfer period 706 is then initiated at time t₃. During the image data non-transfer period 706, the CRC circuit 752 calculates a CRC code of the reproduced icon image data for all icon images contained in the frame image displayed during the image data transfer period 704, and the CRC circuit 754 calculates a CRC code of the original icon image data for all icon images contained in the frame image displayed during the image data transfer period 704. The comparator 756 compares the two CRC codes generated by the CRC circuits 752 and 754 and generates the failure detection signal fail_det based on the result of the comparison. If the two CRC codes do not match, the comparator 756 asserts the failure detection signal fail_det to notify the MCU 270 of the detection of an icon image failure.

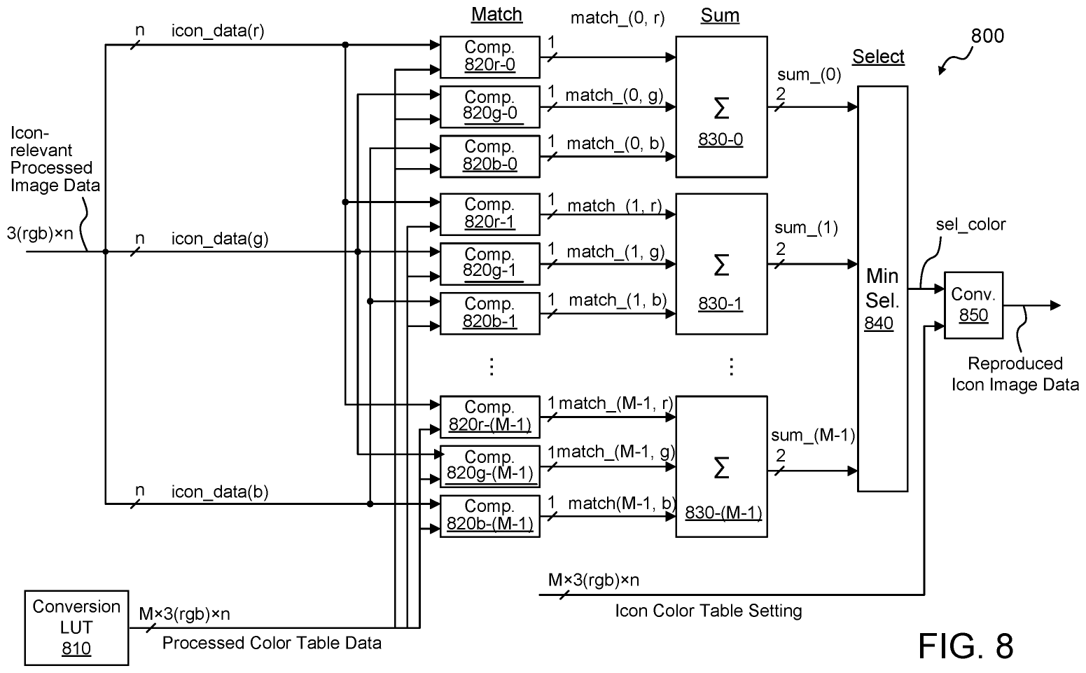

FIG. 8 shows an example partial configuration of the icon data convert circuit 800 relevant to generating reproduced icon image data from icon-relevant processed image data, according to one or more embodiments. In the shown embodiment, icon-relevant processed image data for each pixel of an icon image includes an n-bit R graylevel value icon_data (r), an n-bit G graylevel value icon_data (g), and an n-bit B graylevel value icon_data (b). When converting icon-relevant processed image data for a pixel of interest into reproduced icon image data for that pixel, the icon data convert circuit 800 is configured to determine a most likely color number with reference to the conversion LUT 810, where the most likely color number is the color number for which the R, G, and B graylevel values icon_data (r), icon_data (g), and icon_data (b) of the icon-relevant processed image data are equal to or most closest to the R, G, and B graylevel values of the processed icon color table data. The icon data convert circuit 800 is further configured to determine the R, G, and B graylevel values of the reproduced icon image data for the pixel of interest to be the R, G, and B graylevel values of the most likely color number with reference to the icon color table setting.

In the shown embodiment, the icon data convert circuit 800 includes a set of comparators 820r-0 to 820r-(M−1), 820g-0 to 820g-(M−1), 820b-0 to 820b-(M−1), a set of summing circuits 830-0 to 830-(M−1), a minimum value select circuit 840, and a convertor circuit 850, where M is the number of allowed values of the color number.

For k between 0 and M−1, inclusive, the comparator 820r-k is configured to compare the R graylevel value icon_data (r) of the icon-relevant processed image data with the R graylevel value for the color number “k” defined in the conversion LUT 810 to generate an R comparison result value match_(k, r). In one implementation, the R comparison result value match_(k, r) is “0” when the R graylevel value icon_data (r) of the icon-relevant processed image data is equal to the R graylevel value for the color number “k” and is “1” when the R graylevel value icon_data (r) of the icon-relevant processed image data is not equal to the R graylevel value for the color number “k”. The comparator 820g-k is configured to compare the G graylevel value icon_data (g) of the icon-relevant processed image data with the G graylevel value for the color number “k” defined in the conversion LUT 810 to generate a G comparison result value match_(k, g). In one implementation, the G comparison result value match_(k, g) is “0” when the G graylevel value icon_data (g) of the icon-relevant processed image data is equal to the G graylevel value for the color number “k” and is “1” when the G graylevel value icon_data (g) of the icon-relevant processed image data is not equal to the G graylevel value for the color number “k”. The comparator 820b-k is configured to compare the B graylevel value icon_data (b) of the icon-relevant processed image data with the B graylevel value for the color number “k” defined in the conversion LUT 810 to generate a B comparison result value match_(k, b). In one implementation, the B comparison result value match_(k, b) is “0” when the B graylevel value icon_data (b) of the icon-relevant processed image data is equal to the B graylevel value for the color number “k” and is “1” when the B graylevel value icon_data (b) of the icon-relevant processed image data is not equal to the B graylevel value for the color number “k”.

The summing circuit 830-k is configured to sum up the R, G, and B comparison result values match_(k, r), match_(k, g), and match_(k, b) to generate a sum value sum_(k) which is the sum of the R, G, and B comparison result values match_(k, r), match_(k, g), and match_(k, b). The minimum value select circuit 840 is configured to select the minimum one of the sum values sum_(0) to sum_(M−1) and determine the most likely color number, which is denoted by “sel_color” in FIG. 8, based on the minimum one of the sum values sum_(0) to sum_(M−1). More specifically, when the sum value sum_(k) is minimum, the minimum value select circuit 840 determines the most likely color number sel_color to be “k”. The convertor circuit 850 is configured to determine the R, G, and B graylevel values of the reproduced icon image data for the pixel of interest to be the R, G, and B graylevel values for the most likely color number with reference to the icon color table setting.

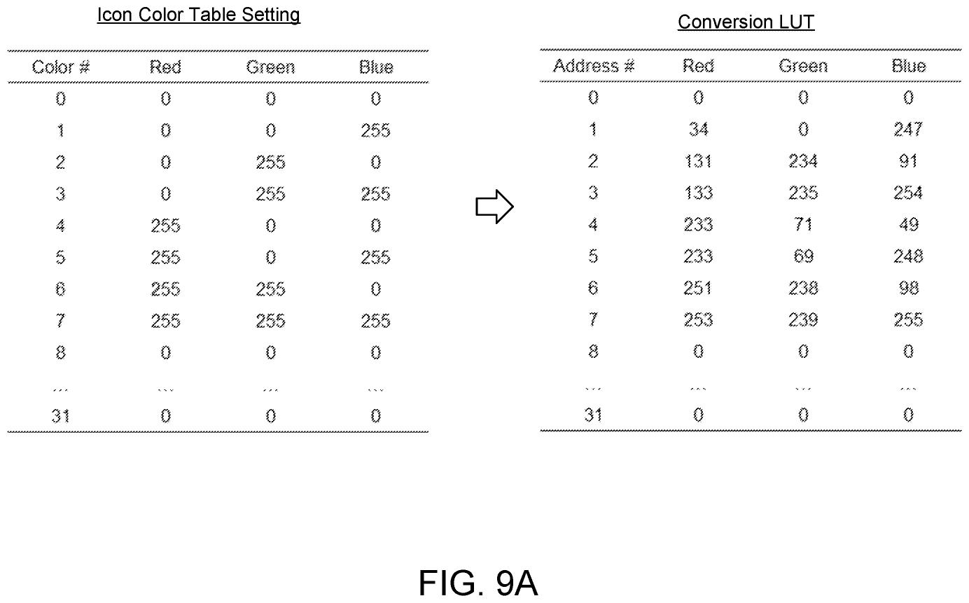

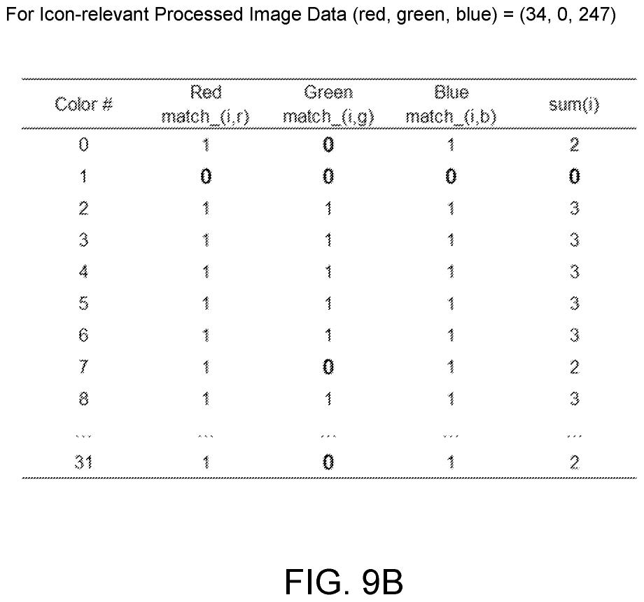

FIG. 9A show examples of the icon color table setting and the contents of the conversion LUT 810, according to one or more embodiments, and FIG. 9B shows examples of the R, G, and B comparison result values match_(k, r), match_(k, g), and match_(k, b) and the sum values sum_(0) to sum_(M−1), according to one or more embodiments. It is noted that the conversion LUT 810 stores the R, G, and B graylevel values of 34, 0, and 247, respectively, at address “1”, which corresponds to the color number “1”. When the R, G, and B graylevel values icon_data (r), icon_data (g), and icon_data (b) of the icon-relevant processed image data for a pixel of interest is 34, 0, and 247, respectively, as shown in FIG. 9B, all of the R, G, and B comparison result values match_(1, r), match_(1, g), and match_(1, b) are 0 and the sum value sum_(1) is the minimum value “0”. Accordingly, the most likely color number is determined as “1”. In this case, with reference to the icon color table setting shown in the left part of FIG. 9A, the R, G, and B graylevel values of the reproduced icon image for the pixel of interest is determined to be 0, 0, and 255, respectively.

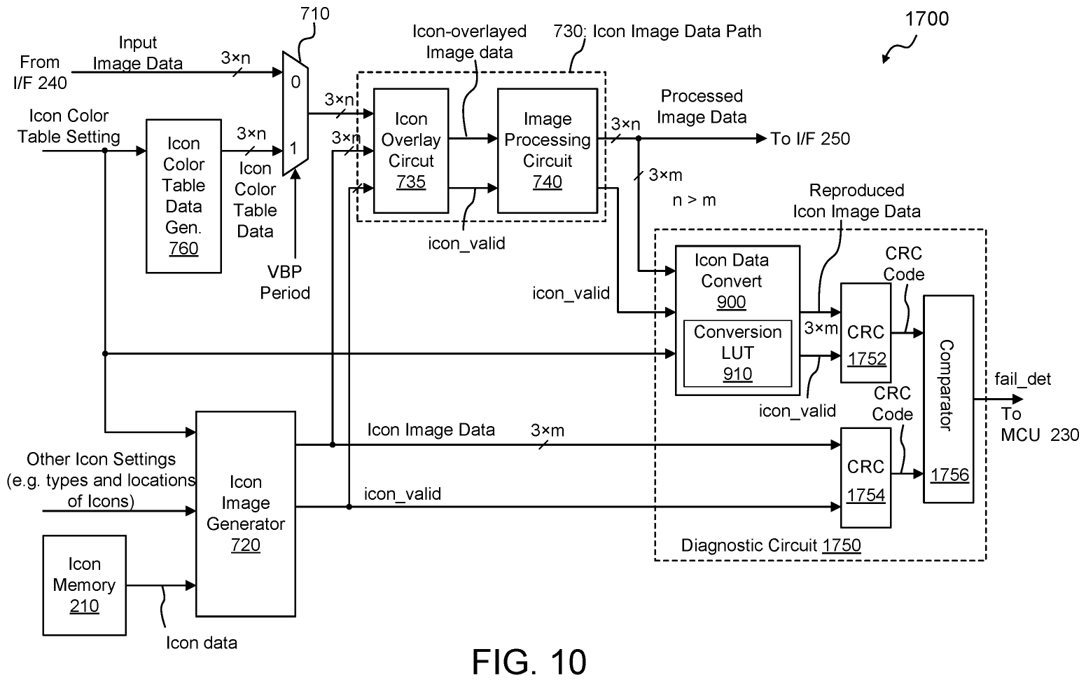

FIG. 10 shows an example configuration of the icon overlay and image processing block, denoted by numeral 1700, in other embodiments. In the shown embodiment, the icon overlay and image processing block 1700 is configured similarly to the icon overlay and image processing block 700 shown in FIG. 3, except that the icon overlay and image processing block 1700 includes a diagnostic circuit 1750 instead of the diagnostic circuit 750. In the embodiment shown in FIG. 10, the icon image data path 730 is configured to handle n-bit R, G, and B graylevel values while the diagnostic circuit 1750 is configured to handle only the upper m bits of the n-bit R, G, and B graylevel values of the processed image data generated by the image processing circuit 740, where m is less than n. The reduction in the bit width of the R, G, and B graylevel values handled by the diagnostic circuit 1750 may facilitate circuit size reduction of the diagnostic circuit 1750. In the shown embodiment, the diagnostic circuit 1750 includes an icon data convert circuit 900, CRC circuits 1752, 1754, and a comparator 1756.

The icon data convert circuit 900 is configured to generate reproduced icon image data with respect to the upper m bits of the R, G, and B graylevel values for each icon image from the processed image data with reference to a conversion LUT 910 and the icon color table setting, wherein the conversion LUT 910 contains information about the input-to-output correlation of the image processing circuit 740. The conversion LUT 910 may be generated in a similar manner to the conversion LUT 810 shown in FIG. 3, except that the conversion LUT 910 stores therein the upper m bits of the R, G, and B graylevel values of the processed icon color table data, which is generated by the image processing circuit 740 applying image processing to the icon color table data. The icon data convert circuit 900 is configured to operate in a manner similar to the icon data convert circuit 800 shown in FIG. 3, except that the icon data convert circuit 900 handles the upper m bits of the n-bit R, G, and B graylevel values of the processed image data.

The CRC circuit 1752 is configured to, for respective icon images, CRC codes of the reproduced icon image data generated with respect to the upper m bits of the R, G, and B graylevel values. In one implementation, the CRC circuit 1752 may be configured to collectively calculate one CRC code of the reproduced icon image data for all the icon images contained in each frame image.

The CRC circuit 1754 is configured to, for the respective icon images, CRC codes of upper m bits of the R, G, and B graylevel values of the original icon image data generated by the icon image generator circuit 720. The CRC circuit 1754 may be configured to collectively calculate one CRC code of the original icon image data for all the icon images contained in that frame image.

The comparator 1756 is configured to compare the CRC codes generated by the CRC circuits 1752 and 1754 and to generate the failure detection signal fail_det based on the result of the comparison. In one implementation, the comparator 1756 may be configured to assert the failure detection signal fail_det to indicate the occurrence of a failure when the CRC codes generated by the CRC circuits 1752 and 1754 are different from each other.

In the embodiment shown in FIG. 10, the image processing performed by the image processing circuit 740 may include “dithering” that intentionally applies noise to generate the processed image data. The dithering may cause small random changes in the R, G, and B grayscale values of the processed image data. The above-described configuration of the diagnostic circuit 1750, which handles only the upper m bits of the n-bit R, G, and B graylevel values of the processed image data, effectively facilitates addressing the small random changes in generating the reproduced icon image data used to detect a failure of the icon image data path 730.

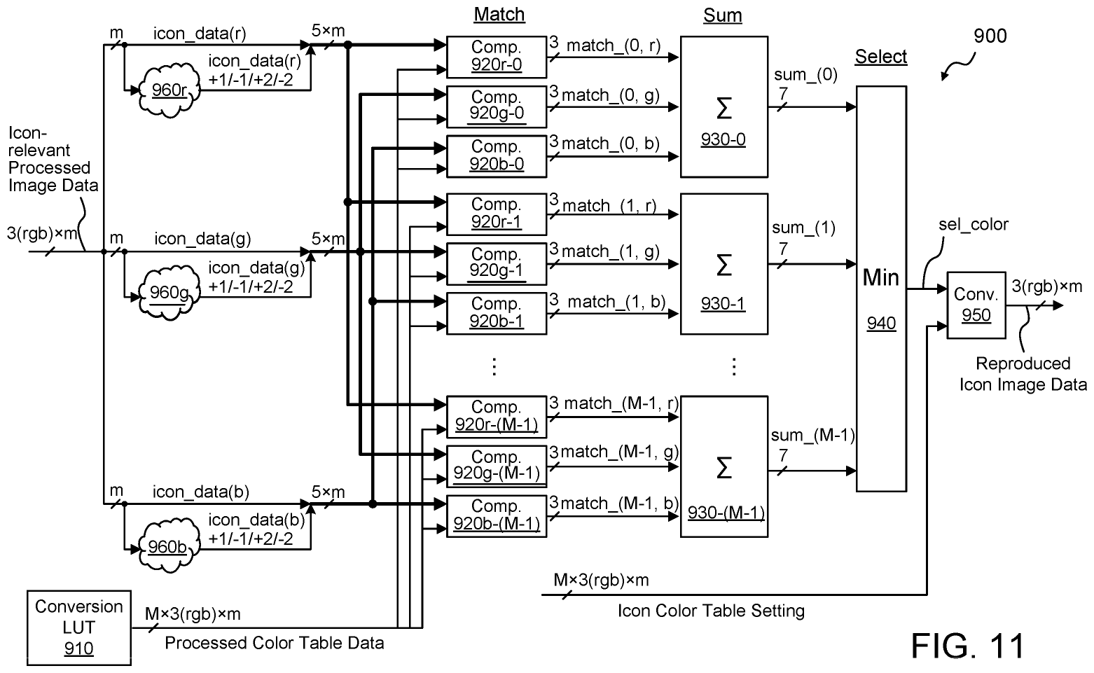

FIG. 11 shows an example partial configuration of the icon data convert circuit 900 relevant to generating reproduced icon image data from icon-relevant processed image data, according to one or more embodiments. In the shown embodiment, icon-relevant processed image data for each pixel of an icon image include an m-bit R graylevel value icon_data (r), an m-bit G graylevel value icon_data (g), and an m-bit B graylevel value icon_data (b). When processing icon-relevant processed image data for a pixel of interest to determine m-bit R, G, and B graylevel values of reproduced icon image data for that pixel, the icon data convert circuit 900 is configured to determine a most likely color number with reference to the conversion LUT 910, where the most likely color number is the color number for which the R, G, and B graylevel values icon_data (r), icon_data (g), and icon_data (b) of the icon-relevant processed image data are most closest to the m-bit R, G, and B graylevel values of the processed icon color table data. The icon data convert circuit 900 is further configured to determine the m-bit R, G, and B graylevel values of the reproduced icon image data for the pixel of interest to be the m-bit R, G, and B graylevel values of the most likely color number with reference to the icon color table setting.

In the shown embodiment, the icon data convert circuit 900 includes a set of comparators 920r-0 to 920r-(M−1), 920g-0 to 920g-(M−1), 920b-0 to 920b-(M−1), a set of summing circuits 930-0 to 930-(M−1), a minimum value select circuit 940, a convertor circuit 950, and a set of variation value generator circuits 960r, 960g, and 960b, where M is the number of allowed values of the color number.

The variation value generator circuit 960r is configured to generate a set of variation values of the m-bit R graylevel value icon_data (r) by adding predetermined difference values to the m-bit R graylevel value icon_data (r). In the shown embodiment, four variation values of the m-bit R graylevel value icon_data (r) are generated by adding +2, +1, −1, and −2 to the R graylevel value icon_data (r). The variation value generator circuit 960r is configured to provide the variation values of the m-bit R graylevel value icon_data (r) to each of the comparators 920r-0 to 920r-(M−1).

Similarly, the variation value generator circuit 960g is configured to generate a set of variation values for the m-bit G graylevel value icon_data (g) by adding predetermined difference values to the m-bit G graylevel value icon_data (g). In the shown embodiment, four variation values of the m-bit G graylevel value icon_data (g) are generated by adding +2, +1, −1, and −2 to the G graylevel value icon_data (g). The variation value generator circuit 960g is configured to provide the variation values of the m-bit G graylevel value icon_data (g) to each of the comparators 920g-0 to 920g-(M−1).

Further, the variation value generator circuit 960b is configured to generate a set of variation values for the m-bit B graylevel value icon_data (b) by adding predetermined difference values to the m-bit B graylevel value icon_data (b). In the shown embodiment, four variation values of the m-bit B graylevel value icon_data (b) are generated by adding +2, +1, −1, and −2 to the B graylevel value icon_data (b). The variation value generator circuit 960b is configured to provide the variation values of the m-bit B graylevel value icon_data (b) to each of the comparators 920b-0 to 920b-(M−1).

For k between 0 and M−1, inclusive, the comparator 920r-k is configured to receive the m-bit R graylevel value icon_data (r) of the icon-relevant processed image data and further to receive the four variation values of the m-bit R graylevel value icon_data (r) from the variation value generator circuit 960r. The comparator 920r-k is configured to compare each of the received five values with the m-bit R graylevel value for the color number “k” defined in the conversion LUT 910 to generate a 3-bit R comparison result value match_(k, r). The R comparison result value match_(k, r) is dependent on which of the five values is equal to the m-bit R graylevel value for the color number “k”. The comparison result value match_(k, r) decreases as the difference between the m-bit R graylevel value icon_data (r) of the icon-relevant processed image data and the m-bit R graylevel value for the color number “k” decreases. More specifically, when the m-bit R graylevel value icon_data (r) of the icon-relevant processed image data is equal to the m-bit R graylevel value for the color number “k”, the R comparison result value match_(k, r) is set to “000”. When one of the variation values of m-bit R graylevel value icon_data (r) generated by adding +1 or −1 is equal to the m-bit R graylevel value for the color number “k”, the R comparison result value match_(k, r) is set to “001”. When one of the variation values of m-bit R graylevel value icon_data (r) generated by adding +2 or −2 is equal to the m-bit R graylevel value for the color number “k”, the R comparison result value match_(k, r) is set to “010”. Otherwise, the R comparison result value match_(k, r) is “100”.

The comparators 920g-k is configured to operate in a manner similar to that of the comparator 920r-k. The comparator 920g-k is configured to receive the m-bit G graylevel value icon_data (g) of the icon-relevant processed image data and further to receive the four variation values of the m-bit G graylevel value icon_data (g) from the variation value generator circuit 960g. The comparator 920g-k is configured to compare each of the received five values with the m-bit G graylevel value for the color number “k” defined in the conversion LUT 910 to generate a 3-bit G comparison result value match_(k, g). The G comparison result value match_(k, g) is dependent on which of the five values is equal to the m-bit G graylevel value for the color number “k”. The comparison result value match_(k, g) decreases as the difference between the m-bit G graylevel value icon_data (g) of the icon-relevant processed image data and the m-bit G graylevel value for the color number “k” decreases. More specifically, when the m-bit G graylevel value icon_data (g) of the icon-relevant processed image data is equal to the m-bit G graylevel value for the color number “k”, the G comparison result value match_(k, g) is set to “000”. When one of the variation values of m-bit G graylevel value icon_data (g) generated by adding +1 or −1 is equal to the m-bit G graylevel value for the color number “k”, the G comparison result value match_(k, g) is set to “001”. When one of the variation values of m-bit G graylevel value icon_data (g) generated by adding +2 or −2 is equal to the m-bit G graylevel value for the color number “k”, the G comparison result value match_(k, g) is set to “010”. Otherwise, the G comparison result value match_(k, g) is “100”.

The comparators 920b-k is also configured to operate in a manner similar to that of the comparator 920r-k. The comparator 920b-k is configured to receive the m-bit B graylevel value icon_data (b) of the icon-relevant processed image data and further to receive the four variation values of the m-bit B graylevel value icon_data (b) from the variation value generator circuit 960b. The comparator 920b-k is configured to compare each of the received five values with the m-bit B graylevel value for the color number “k” defined in the conversion LUT 910 to generate a 3-bit B comparison result value match_(k, b). The B comparison result value match_(k, b) is dependent on which of the five values is equal to the m-bit B graylevel value for the color number “k”. The comparison result value match_(k, b) decreases as the difference between the m-bit B graylevel value icon_data (b) of the icon-relevant processed image data and the m-bit B graylevel value for the color number “k” decreases. More specifically, when the m-bit B graylevel value icon_data (b) of the icon-relevant processed image data is equal to the m-bit B graylevel value for the color number “k”, the B comparison result value match_(k, b) is set to “000”. When one of the variation values of m-bit B graylevel value icon_data (b) generated by adding +1 or −1 is equal to the m-bit B graylevel value for the color number “k”, the B comparison result value match_(k, b) is set to “001”. When one of the variation values of m-bit B graylevel value icon_data (b) generated by adding +2 or −2 is equal to the m-bit B graylevel value for the color number “k”, the B comparison result value match_(k, b) is set to “010”. Otherwise, the B comparison result value match_(k, b) is “100”.

The summing circuit 930-k is configured to sum up the 3-bit R, G, and B comparison result values match_(k, r), match_(k, g), and match_(k, b) to generate a sum value sum_(k). The sum value sum_(k) is generated such that the sum value sum_(k) decreases as the m-bit R, G, and B graylevel values icon_data (r), icon_data (g), and icon_data (b) of the icon-relevant processed image data are closer to the m-bit R, G, and B graylevel values for the color number “k”. In one implementation, the sum value sum_(k) is a seven-bit value, referred to as sum [6:0], calculated in accordance with the following expressions:

sum[1:0]=r[0]+g[0]+b[0];

sum[2]=r[0]& g[0]& b[0];

sum[4:3]=r[1]+g[1]+b[1];

sum[5]=r[1]& g[1]& b[1]; and

sum[6]=r[2]|g[2]|b[2];
where sum [6] is the most significant bit of sum [6:0]; sum [5] is the second most significant bit of sum [6:0]; sum [4:3] are the third and fourth most significant bits of sum [6:0]; sum [2] is the third least significant bit of sum [6:0], sum [1:0] are the least significant and second least significant bits of sum [6:0]; r[2], g[2], and b[2] are the most significant bits of the 3-bit R, G, and B comparison result values match_(k, r), match_(k, g), and match_(k, b), respectively; r[1], g[1], and b[1] are the second most significant bits of the 3-bit R, G, and B comparison result values match_(k, r), match_(k, g), and match_(k, b), respectively; r[0], g[0], and b[0] are the least significant bits of the 3-bit R, G, and B comparison result values match_(k, r), match_(k, g), and match_(k, b), respectively; “+” denotes the addition operation; “&” denotes the AND logical operation; and “I” denotes the OR logical operation.

The minimum value select circuit 940 is configured to select the minimum one of the sum values sum_(0) to sum_(M−1) and determine the most likely color number, denoted by “sel_color” in FIG. 11, based on the minimum one of the sum values sum_(0) to sum_(M−1). More particularly, when the sum value sum_(k) is minimum, the minimum value select circuit 940 determines the most likely color number to be “k”. The convertor circuit 950 is configured to determine the R, G, and B graylevel values of the reproduced icon image data for the pixel of interest to be the R, G, and B graylevel values of the most likely color number sel_color with reference to the icon color table setting.

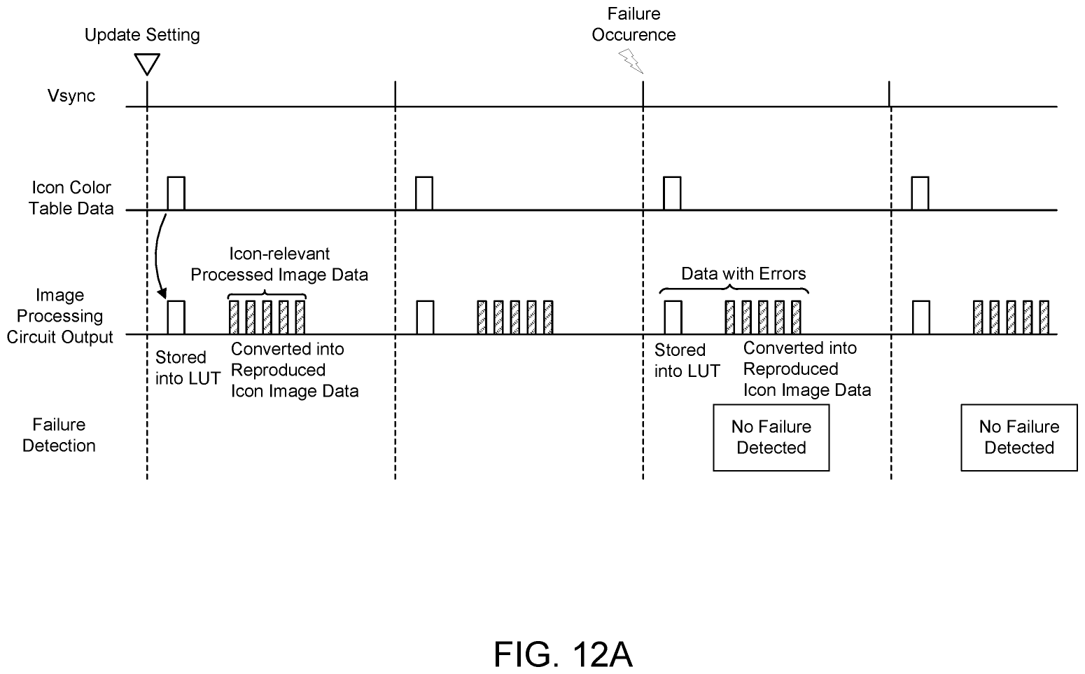

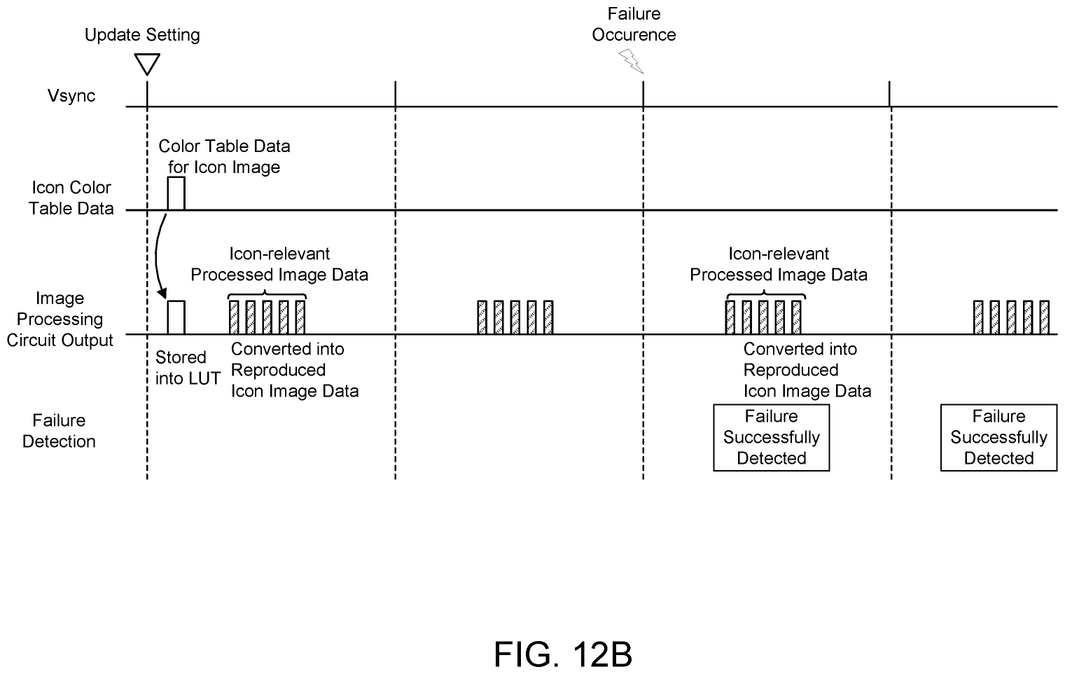

FIG. 12A is a timing diagram showing an example operation of the icon overlay and image processing block (shown in FIGS. 3 and 10), according to one or more embodiments. In the shown embodiment, the process of generating processed icon color table data and updating the conversion LUT with the processed icon color table data is performed in every frame period. In the embodiment of FIG. 12A, however, a failure of the icon image data path may not be detected if the failure occurs in a period between the image data transfer and the subsequent assertion of the vertical synchronization signal Vsync. This is because the conversion LUT may be updated with processed icon color table data containing errors generated by the failed icon overlay and image processing block, and the icon-relevant processed image data may contain the same errors.

In alternative embodiments, as shown in FIG. 12B, the process of generating processed icon color table data and updating the conversion LUT with the processed icon color table data is performed in response to an update of one or more settings of the icon overlay and image processing block. The process of generating processed icon color table data and updating the conversion LUT may be performed only in the frame period immediately following the update of the one or more settings of the icon overlay and image processing block. In this case, the conversion LUT is not updated with processed icon color table data containing errors after the occurrence of a failure of the icon image data path 730, resulting in a successful detection of the failure.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Exemplary embodiments are described herein. Variations of those exemplary embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A circuit, comprising:
an icon image data path comprising:
an icon overlay circuit configured to generate icon-overlayed image data based on input image data corresponding to a base image and icon image data corresponding to an icon image, wherein the icon-overlayed image data corresponds to an icon-overlayed image in which the icon image is overlayed on the base image; and
an image processing circuit configured to process the icon-overlayed image data to generate processed image data; and
a diagnostic circuit configured to:
extract icon-relevant processed image data from the processed image data;
convert the icon-relevant processed image data into reproduced icon image data based on input-to-output correlation of the image processing circuit; and
detect a failure of the icon image data path based on the icon image data and the reproduced icon image data.

2. The circuit of claim 1, wherein detecting the failure of the circuit is performed based on upper bits of the icon image data and upper bits of the reproduced icon image data without referring to remaining lower one or more bits of the icon image data and remaining lower one or more bits of the reproduced icon image data.

3. The circuit of claim 2, wherein processing the icon-overlayed image data to generate processed image data comprises applying dithering to the icon-overlayed image data.

4. The circuit of claim 1, wherein the diagnostic circuit is configured to store a conversion lookup table based on the input-to-output correlation of the image processing circuit,
wherein converting the icon-relevant processed image data into the reproduced icon image data comprises referring to the conversion lookup table.

5. The circuit of claim 4, further comprising an icon color table data generator circuit configured to generate icon color table data that comprises original red (R), green (G), and blue (B) graylevel values for each of a predetermined set of colors used in the icon image,
wherein the image processing circuit is further configured to process the icon color table data to generate processed icon color table data, and
wherein storing the conversion lookup table is based on the processed icon color table data.

6. The circuit of claim 5, wherein the processed icon color table data comprises processed R, G, and B graylevel values for each of the predetermined set of colors generated by processing the original R, G, and B graylevel values of the icon color table data for each of the predetermined set of colors, and
wherein the conversion lookup table contains the processed R, G, and B graylevel values for each of the predetermined set of colors.

7. The circuit of claim 6, wherein converting the icon-relevant processed image data into the reproduced icon image data comprises:
identifying a color for each pixel of the icon image based on R, G, and B graylevel values of the icon-relevant processed image data for a respective pixel of the icon image with reference to the conversion lookup table; and
determining R, G, and B graylevel values of the reproduced icon image data for each pixel of the icon image to be equal to the original R, G, and B graylevel values of the identified color for a respective pixel of the icon image.

8. The circuit of claim 5, wherein processing the icon color table data to generate the processed icon color table data is performed in an image data non-transfer period, and
wherein the diagnostic circuit is configured to update the conversion lookup table based on the processed icon color table data in the image data non-transfer period.

9. The circuit of claim 8, wherein processing the icon color table data to generate the processed icon color table data and updating the conversion lookup table based on the processed icon color table data are performed in response to a change in a setting of the image processing circuit.

10. The circuit of claim 4, further comprising an icon color table data generator circuit configured to generate icon color table data that comprises original R, G, and B graylevel values for each of a predetermined set of colors used in the icon image,
wherein the image processing circuit is further configured to process the icon color table data to produce processed R, G, and B graylevel values for each of the predetermined set of colors by processing the original R, G, and B graylevel values of the icon color table data for each of the predetermined set of colors, and
wherein the conversion lookup table contains upper bits of the processed R, G, and B graylevel values for each of the predetermined set of colors.

11. The circuit of claim 10, converting the icon-relevant processed image data into the reproduced icon image data comprises:
determining a color number for each pixel of the icon image based on the R, G, and B graylevel values of the icon-relevant processed image data for a respective pixel of the icon image with reference to the conversion lookup table; and
determining R, G, and B graylevel values of the reproduced icon image data for each pixel of the icon image to be equal to values of upper bits of the original R, G, and B graylevel values of the determined color number for the respective pixel of the icon image,
wherein detecting the failure of the circuit is performed based on upper bits of the icon image data and the R, G, and B graylevel values of the reproduced icon image data.

12. The circuit of claim 1, wherein diagnostic circuit is further configured to:
calculate a first error detection code of the icon image data for one or more icons contained in the icon-overlayed image for one frame; and
calculate a second error detection code of the reproduced icon image data for the one or more icons contained in the icon-overlayed image for the one frame,
wherein detecting the failure of the circuit is based on comparison between the first error detection code and the second error detection code.

13. The circuit of claim 12, wherein the first error detection code is a first cyclic redundancy check (CRC) code, and
wherein the second error detection code is a second CRC code.

14. The circuit of claim 1, wherein the circuit is a bridge circuit which comprises an interface configured to provide the processed image data to a display driver configured to drive a display panel.

15. The circuit of claim 1, wherein the circuit is a display driver circuit configured to drive a display panel based on the processed image data.

16. A display system comprising:
a display panel;
an icon image data path comprising:
an icon overlay circuit configured to generate icon-overlayed image data based on input image data corresponding to a base image and icon image data corresponding to an icon image, wherein the icon-overlayed image data corresponds to an icon-overlayed image in which the icon image is overlayed on the base image; and
an image processing circuit configured to process the icon-overlayed image data to generate processed image data;
a diagnostic circuit configured to:
extract icon-relevant processed image data from the processed image data;
convert the icon-relevant processed image data into reproduced icon image data based on input-to-output correlation of the image processing circuit; and
detect a failure of the icon image data path based on the icon image data and the reproduced icon image data; and
a driver circuit configured to drive the display panel based on the processed image data.

17. The display system of claim 16, wherein the diagnostic circuit is configured to store a conversion lookup table based on the input-to-output correlation of the image processing circuit,
wherein converting the icon-relevant processed image data into the reproduced icon image data comprises referring to the conversion lookup table.

18. The display system of claim 17, further comprising an icon color table data generator circuit configured to generate icon color table data that comprises original red (R), green (G), and blue (B) graylevel values for each of a predetermined set of colors used in the icon image,
wherein the image processing circuit is further configured to process the icon color table data to generate processed icon color table data, and
wherein storing the conversion lookup table is based on the processed icon color table data.

19. The display system of claim 18, wherein processing the color table data to generate the processed color table data is performed in an image data non-transfer period, and
wherein the diagnostic circuit is configured to update the conversion lookup table based on the processed color table data in the image data non-transfer period.

20. A method, comprising:
generating, by an icon overlay circuit of an icon image data path, icon-overlayed image data based on input image data corresponding to a base image and icon image data corresponding to an icon image, wherein the icon-overlayed image data corresponds to an icon-overlayed image in which the icon image is overlayed on the base image;
processing, by an image processing circuit of the icon image data path, the icon-overlayed image data to generate processed image data;
extracting icon-relevant processed image data from the processed image data;
converting the icon-relevant processed image data into reproduced icon image data based on input-to-output correlation of the image processing circuit; and
detecting a failure of the icon image data path based on the icon image data and the reproduced icon image data.
